(19) United States
(12) Patent Application Publication
(10) Pub. No.: US 2009/0160759 A1
(43) Pub. Date: Jun. 25, 2009

(54) MOVING PARTICLE DISPLAY DEVICE

(75) Inventors: Steven Charles Deane, Redhill (GB); Ian French, Brighton (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/300,644

(22) PCT Filed: May 10, 2007
(86) PCT No.: PCT/IB07/51773

§ 371 Date: Nov. 13, 2008

(30) Foreign Application Priority Data
May 17, 2006 (EP) 06114118.0
Nov. 28, 2006 (EP) 06124872.0

(51) Int. Cl. G09G 3/34; G02F 1/167

(52) U.S. Cl. 345/107; 359/296

(57) ABSTRACT

A moving particle display device comprises an array of rows and columns of display pixels (41,42,43,44), a plurality of row address lines (Row1,Row2;72; 112), each row address line for addressing a respective row of pixels and a plurality of column address lines (Col1,Col2;76; 108), each for providing pixel data to a respective column of pixels. A plurality of discharge column lines (82) is provided. A pixel is addressed by addressing a row of pixels and providing data to the pixels in the addressed row using the column address lines (Col1,Col2;76; 108). A charge flow from a column address line to an addressed pixel in the column flows to a respective discharge column line (82). By having discharge lines in the column direction, when a row of pixels is addressed, a current flow through the pixel, which is used to load data into the pixel from a column address line, passes to a column discharge line. In this way, the column discharge line only carries a current flow associated with a small number of pixels from the row. This enables the width of the discharge lines to be kept to a minimum, and it also enables the number of pixels in a row to be scaled without requiring the discharge line to carry an increased current.

### FIELD OF THE INVENTION

The invention relates to a moving particle display device, and in particular to a pixel electrode layout for such a display.

### BACKGROUND OF THE INVENTION

Previous moving particle displays, such as electrophoretic displays, have been known for many years; for example from U.S. Pat. No. 3,612,758.

The fundamental principle of electrophoretic displays is that the appearance of an electrophoretic material encapsulated in the display is controllable by means of electrical fields.

To this end the electrophoretic material typically comprises electrically charged particles having a first optical appearance (e.g. black) contained in a fluid such as liquid or air having a second optical appearance (e.g. white), different from the first optical appearance. The display typically comprises a plurality of pixels, each pixel being separately controllable by means of separate electric fields supplied by electrode arrangements. The particles are thus movable by means of an electric field between visible positions, invisible positions, and possibly also intermediate semi-visible positions. Thereby the appearance of the display is controllable. The invisible positions of the particles can for example be in the depth of the liquid or behind a black mask.

The distance that a particle moves through electrophoretic material is roughly proportional to the integral of the applied electric field with respect to time. Hence the greater the electric field strength, and the longer the electric field is applied for, the further the particles will move.

A more recent design of an electrophoretic display is described by E Ink Corporation in, for example, WO99/53373.

In-plane electrophoretic displays use electric fields that are lateral to the display substrate to move particles from a masked area hidden from the viewer to a viewing area. The larger the number of particles that are moved to/from the viewing area, the greater the change in the optical appearance of the viewing area. Applicant's International Application WO2004/008238 gives an example of a typical in-plane electrophoretic display.

Typically, the extreme (e.g. black and white) optical states of moving particle displays are well defined, with all particles being attracted to one particular electrode. However, in intermediate optical states (grey levels), there will always be a spatial spread among the particles.

Grey scales or intermediate optical states in electrophoretic displays are generally provided by applying voltage pulses for specified time periods, in order to spatially distribute particles through the electrophoretic material.

It has been recognized that electrophoretic display devices enable low power consumption as a result of their bistability (an image is retained with no voltage applied), and they can enable thin and bright display devices to be formed, as there is no need for a backlight or polarizer. They may also be made from plastics materials, and there is also the possibility of low cost reel-to-reel processing in the manufacture of such displays.

If costs are to be kept as low as possible, passive addressing schemes are employed. The most simple configuration of display device is a segmented reflective display, and there are a number of applications where this type of display is sufficient. A segmented reflective electrophoretic display has low power consumption, good brightness and is also bistable in operation, and therefore able to display information even when the display is turned off.

However, improved performance and versatility is provided using a matrix-addressing scheme. An electrophoretic display using passive matrix addressing typically comprises a lower electrode layer, a display medium layer, and an upper electrode layer. Biasing voltages are applied selectively to electrodes in the upper and/or lower electrode layers to control the state of the portion(s) of the display medium associated with the electrodes being biased.

One particular type of electrophoretic display device uses so-called “in plane switching”. This type of device uses movement of the particles selectively laterally in the display material layer. When the particles are moved towards lateral electrodes, an opening appears between the particles, through which an underlying surface can be seen. When the particles are randomly dispersed, they block the passage of light to the underlying surface and the particle color is seen. The particles may be colored and the underlying surface black or white, or else the particles can be black or white, and the underlying surface colored.

An advantage of in-plane switching is that the device can be adapted for transmissive operation, or transflective operation. In particular, the movement of the particles creates a passageway for light, so that both reflective and transmissive operation can be implemented through the material. This enables illumination using a backlight rather than reflective operation. The in-plane electrodes may all be provided on one substrate, or else both substrates may be provided with electrodes.

Active matrix addressing schemes are also used for electrophoretic displays, and these are generally required when a faster image update is desired for bright full color displays with high-resolution grey scale. Such devices are being developed for signage and billboard display applications, and as (pixilated) light sources in electronic window and ambient lighting applications.

The addressing of a display using a matrix-addressing scheme involves addressing the rows of pixels in turn. When one row is addressed, data is provided to columns lines, thereby loading pixel data in each pixel along the addressed row. This addressing causes a charge flow to the pixel, and the charge flow is dissipated from the pixel along a discharge line, which may be coupled to ground.

One problem with moving particle displays is that the pixels have a large capacitance, particularly in comparison to liquid crystal display technology. As a result, the loading of data into a pixel can require a significant charge flow, which in turn causes a significant current to flow along the discharge line. Furthermore, the pixels of an electrophoretic display device are typically loaded with data by charging the pixels with voltages, which are the same polarity for all pixels. As a result, if the currents associated with the loading of data into multiple pixels flow to a common discharge line, these currents accumulate. The discharge line then needs to be designed with sufficiently low resistance to allow these current flows, without giving voltage variations along the length of the discharge line.

### SUMMARY OF THE INVENTION

According to a first aspect of the invention, there is provided a moving particle display device comprising:

an array of rows and columns of display pixels;

a plurality of row address lines, each row address line for addressing a respective row of pixels;

a plurality of column address lines, each for providing pixel data to a respective column of pixels; and

a plurality of discharge column lines,

wherein a pixel is addressed by addressing a row of pixels and providing data to the pixels in the addressed row using the column address lines, and wherein a charge flow from a column address line to an addressed pixel in the column flows to a respective discharge column line.

The display device of the invention has discharge lines in the column direction. This means that when a row of pixels is addressed, a current flow through the pixel, which is used to load data into the pixel from a column address line, passes to a column discharge line. In this way, the column discharge line only carries a current flow associated with a small number of pixels from the row. For example, the current flow through a single pixel can pass to the discharge line, or the current from two adjacent pixels if a column discharge line is shared between two neighboring columns of pixels. This enables the width of the discharge lines to be kept to a minimum, and it also enables the number of pixels in a row to be scaled without requiring the discharge line to carry an increased current.

Each pixel can comprise a cell comprising a sealed region containing a fluid in which particles are suspended, wherein the movement of particles within each cell is controlled to define a cell state, the cell states of all device cells together defining an output of the device, The device is preferably an electrophoretic display device, in which the moving particles comprise electrophoretic particles. The device may comprise an in-plane switching electrophoretic display device.

In one example, each column discharge line is shared between two adjacent columns of pixels. This means each discharge line carries the current flow through two pixels, but this reduces the number of conductor lines, which need to pass along the display area. Each column discharge line may instead be associated with a single column of pixels.

The invention also provides a method of driving a moving particle display device comprising an array of rows and columns of display pixels, the method comprising:

addressing rows of pixel in a sequence, a row of pixels being selected by applying a row select signal to a respective row address line;

when a row of pixels is addressed, loading the pixels of the row with data using column address lines,

wherein during loading of data from a column address line, a charge flow from the column address line to an addressed pixel in the column is discharged along a respective discharge column line.

### BRIEF DESCRIPTION OF THE DRAWINGS

Further features of the invention will become apparent from the following non-limiting examples, and with reference to the accompanying drawings, in which:

FIG. 1 shows a flow diagram of a method for driving a display device, which can be used for driving a display device of the invention;

FIG. 2 shows a diagram of an electrophoretic cell, which can be used in the device of the invention;

FIG. 3 shows a diagram of an in-plane electrophoretic cell can be used in the device of the invention;

FIG. 4 shows a plan diagram of two pairs of the electrophoretic cells of FIG. 3;

FIG. 5 shows a circuit diagram of a display device according to an embodiment of the invention that incorporates the two pairs of electrophoretic cells of FIG. 4;

FIG. 6 shows a timing diagram for driving the display device of FIG. 5;

FIG. 7 shows a first example of pixel electrode layout of the invention; and

FIG. 8 shows a second example of pixel electrode layout of the invention.

The same reference numerals are used throughout the Figures in order to indicate the same or similar features. The Figures are not drawn to scale, and hence no attempts to derive relative dimensions/time periods from them are intended to be made.

### DETAILED EMBODIMENTS

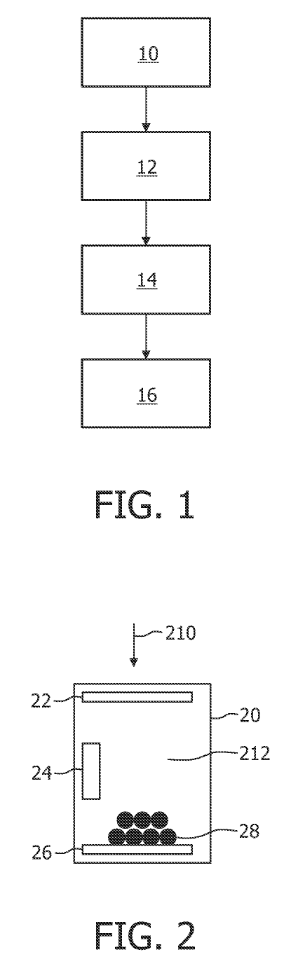

FIG. 1 shows a flow diagram of a method for driving a moving particle display device, which can be used for the display device of the invention. The moving particle display device typically has hundreds or thousands of moving particle cells, each of which form a first or second cell of a pair. Each cell comprises movable charged particles, and has a storage region into which at least some of the movable charged particles may be moved, a gate region into which at least some of the movable charged particles may be moved, and a display region into which at least some of the movable charged particles may be moved.

A cell's display region is the region of the cell that determines the cell's optical state. The optical state is determined by the number of (movable charged) particles that are within the cell's display region. The cell's gate region is a region of the cell from which particles are moved into the display region. The cell's storage region is a region where the cell's particles can be temporarily stored, and is typically used to store excess particles that are not needed in the display region.

At step 10, the first cell of a pair is set to a storage mode by electrically attracting substantially all of the cell's particles to the cell's storage region. The term storage mode is used throughout this document to denote a cell that has substantially all of its particles in its storage region.

At step 12, the second cell is set to a gate mode by attracting substantially all of the cell's particles to the cell's gate region. The term gate mode is used throughout this document to denote a cell that has substantially all of its particles in its gate region.

At step 14, a display number of particles is attracted from the first cell's storage region to the cell's gate region, and then from the gate region to the display region, thereby setting the cell to a target optical state. The display number of a cell's particles is the number/proportion of the cell's particles that are transferred into the cell's display region in order to set the cell's optical state.

At step 16, a surplus number of particles are attracted from the second cell's gate region to the cell's storage region, leaving a display number of particles in the cell's gate region. Then the display number of particles in the gate region is attracted to the display region, thereby setting the cell to a target optical state. The surplus number of a cell's particles is the number or proportion of the cell's particles that must be moved from the cell's gate region to the cell's storage region, in order to leave a display number of particles in the cell's gate region.

These method steps may take place in different orders or coincident with one another. For example, the first cell can be set to the storage mode at the same time as the second cell is set to the gate mode. Then the first cell's display number of particles are moved to the cell's gate region, then the second cell's surplus number of particles are moved to the cell's storage region, and then the display number of particles in each cell's gate region are simultaneously moved to each cell's display region.

FIG. 2 shows a diagram of an electrophoretic cell 20 suitable for use in the method of FIG. 1. The diagram shows a cross-sectional view of a single cell 20 that is filled with an opaque white fluid 212 and with movable black charged particles 28. To control the movements of the particles 28, the cell 20 has cell electrodes comprising a transparent display electrode 22, a gate electrode 24, and a storage electrode 26. The cell is viewed from direction 210, and so the cell's current optical state is white, since all the black 30 particles are down in the region of the storage electrode 26 and are obscured from view by the opaque white fluid 212.

If cell 20 were to be driven as a first cell, then a display number of the black particles 28 would be attracted up to the region of the gate electrode 24, and then up to the transparent display electrode 22, giving the cell an optical state of black or of a shade of grey when viewed from direction 210.

If the cell were to be driven as a second cell, then firstly all the particles 28 would be attracted to the region of the gate electrode 24, setting the cell in the gate mode. Then a surplus number of the particles 28 would be attracted down to the region of the storage electrode 26, leaving a display number of the particles 28 in the region of the gate electrode 24. Then the display number of particles 28 would be attracted up to the transparent display electrode 22, giving the cell an optical state of black or of a shade of grey when viewed from direction 210.

Whether the cell appears to be black or a shade of grey clearly depends on the number of particles that are moved to the display electrode 22. Hence the larger the display number of particles, the closer to black the cell's optical state will be.

In other embodiments, the fluid and particle colors may be different to those described above, in order to give different colored optical states.

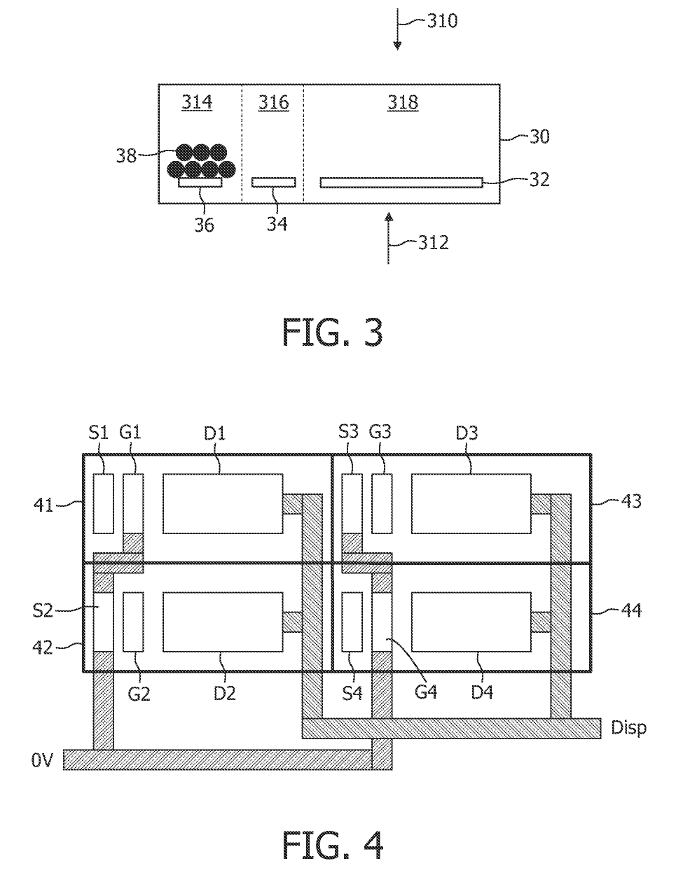

FIG. 3 shows a diagram of an in-plane electrophoretic cell suitable for use in the method of FIG. 1. The in-plane electrophoretic cell 30 is shown in cross-section, and is filled with a transparent fluid and with movable black charged particles 38. The cell 30 has cell electrodes comprising a transparent display electrode 32, a gate electrode 34, and a storage electrode 36. For ease of understanding, two dashed lines are superimposed on the diagram to roughly indicate where the divisions between the storage region 314, gate region 316, and display region 318 would lie. A light source 312 is positioned beneath the display region 318, such that the cell operates transmissively. The cell is currently in a storage mode, since all of the particles 28 are in the cell's storage region 314. Hence the cell has a transparent optical state since none 30 of the black particles are in the display region 318, and so white light from light source 312 is seen when the cell is viewed from direction 310.

If cell 30 were to be driven as a first cell, then a display number of the black particles 38 would be attracted from the region 314 of the storage electrode and to the region 316 of the gate electrode 34, and then to the region 318 of the transparent display electrode 32, where the display number of particles would obscure the light from light source 312, making the cell look black or a shade of grey when viewed from direction 310.

If the cell were to be driven as a second cell, then firstly all the particles 38 would be attracted to the region 316 of the gate electrode 34, setting the cell to the gate mode. Then a surplus number of the particles 38 would be attracted to the region 314 of the storage electrode 36, leaving a display number of the particles 38 in the region 316 of the gate electrode 34. Then the display number of particles 38 would be attracted to the region 318 of the transparent display electrode 32, where they would obscure the light from light source 312, making the cell look black or a shade of grey when viewed from direction 310.

Whether the cell appears to be black or a shade of grey clearly depends on the number of particles that are moved to the region of the display electrode 32. The higher the display number of particles, the more the white light from light source 312 will be obscured, and the closer the cell will appear to black when viewed from direction 310.

In other arrangements, the colors of the light source 312 and the particles 38 may be different to those described above. For example, in an embodiment comprising six cells that are treated as three pairs of cells, the first pair of cells has red light sources beneath them, the second pair of cells has green light sources beneath them, and the third pair of cells has blue light sources beneath them. The particles of all six cells are colored black, and hence the six cells together constitute a single RGB color pixel.

The in-plane electrophoretic cell of FIG. 3 may be modified by replacing the light source 312 with a reflecting surface, e.g. a white surface placed below the transparent conductor 32, to give reflective instead of transmissive operation. Then, when no black particles are in the display region, the cell will appear white, and when multiple black particles are in the display region, the cell will appear black or a shade of grey.

FIG. 4 shows a plan diagram of two pairs of the electrophoretic cells of FIG. 3, suitable for use in the method of FIG. 1. For simplicity, these cells are reflective cells that appear white when the cell has a transparent optical state, and that appear black or a shade of grey when the cell has a respective optical state of black or a shade of grey. The reflector, not shown on FIG. 4 for clarity, is placed beneath the transparent display electrodes D1-D4. In other embodiments, the display electrodes themselves may be reflective rather than transparent, to reduce the need for a separate reflector.

In the diagram of FIG. 4, cells 41 and 42 form one pair of cells, and cells 43 and 44 form another pair of cells. Each cell has cell electrodes comprising a storage electrode (S1-S4), a gate electrode (G1-G4), and a display electrode (D1-D4). The cell electrodes D1-D4 are all connected to an address electrode (Disp).

The movable particles within each cell are negatively charged, and therefore move towards higher, positive, electric potentials, i.e. in the opposite direction to applied electric fields. For example, the address electrode Disp may be driven to a high electric potential to move (attract) particles from each cell's gate region to each cell's display region.

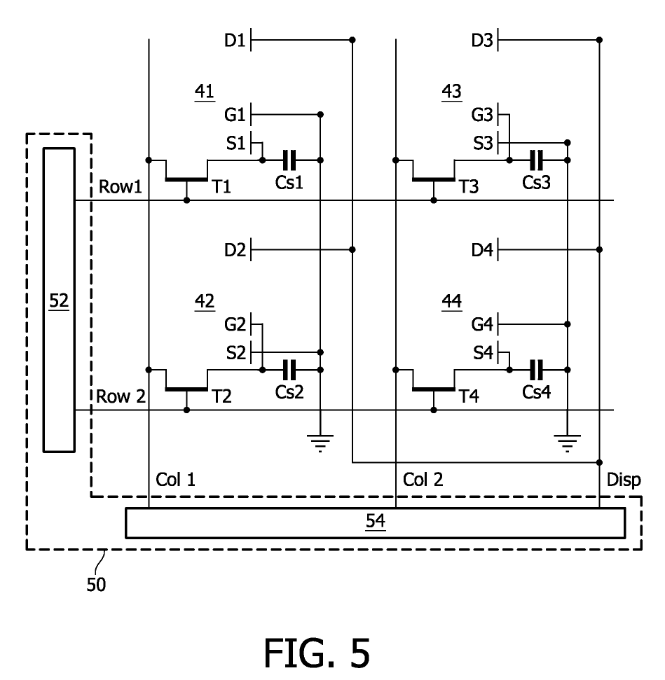

The cell electrodes G1, S2, S3, and G4 are all connected to 0V. The cell electrodes S1, G2, G3, S4 are each controlled separately, using an active matrix comprising active switching circuitry and row and column address electrodes. The active matrix is not shown on FIG. 4 for clarity, but is shown on FIG. 5 and described in detail further below. The cells 41 and 44 are driven as first cells that are set to the storage mode by applying positive voltages to S1 and S4, thereby attracting the cells' particles to S1 and S4. The cells 42 and 43 are driven as second cells that are set to the gate mode by applying positive voltages to G2 and G3, thereby attracting the cells' particles to G2 and G3. Additionally, when setting the cells to storage or gate modes, the address electrode Disp is driven to a negative voltage, thereby attracting particles from the cells' display regions to the cells' gate regions.

In the diagram of FIG. 4, the first and second cells of each pair are shown as being immediately adjacent to one another. Alternatively, the first and second cells of a pair may be spaced apart from each other by other cells. In this case the first and second cells are still considered as being adjacent to one another, as light from the first and second cells will still appear to merge together when the cells are viewed from a distance, such that errors in the cell's optical states will still appear to compensate one another.

As shown in FIGS. 4 and 5, each cell is connected to earth (0V) by means of a column line. For the cells 41 and 42, this column line connects to the terminals G1 and S2. These column lines act as discharge lines. As will be explained further below with reference to the circuit diagram of FIG. 5, currents flow to these column discharge lines when cells are addressed. As these run in the column direction, when one row of cells is addressed, the current resulting from the addressing of each pixel will flow to a respective column discharge line. This keeps the current flowing in the discharge lines to a minimum.

FIG. 5 shows a circuit diagram of a display device according to an embodiment of the invention that incorporates the two pairs of electrophoretic cells of FIG. 4. The circuit diagram shows electronic drive circuitry 50 and address electrodes Row 1, Row 2, Col 1, and Col 2 that are used to control the electric potentials applied to the S1, G2, G3, and S4 cell electrodes. The electronic drive circuitry 50 comprises row driver 52 for driving address electrodes Row 1 and Row 2, and column driver 54 for driving address electrodes Col 1, Col 2, and Disp.

Thin Film Transistors (TFTs) T1-T4 are used as active switches that are controlled by the Row 1 and Row 2 address electrodes to selectively apply the voltages on the Col 1 and Col 2 address electrodes to the cell electrodes S1, G2, G3 and S4. Capacitors Cs1-Cs4 are used to help maintain the applied column voltages on the cell electrodes S1, G2, G3, and S4, even after the corresponding TFTs have been switched off. In a further embodiment (not shown), the addressing electrodes do not control active switching circuitry for controlling S1, G2, G3, and S4, and so form part of a passive matrix. For example, in a passive matrix, the cell electrodes may be connected directly to the address electrodes, as will be apparent to those skilled in the art.

The drive circuitry 50 may be an arrangement of TFTs on the display substrate, a Field Programmable Gate Array (FPGA), an application-specific integrated circuit (ASIC), or any other circuit configured to generate drive signals for driving the address electrodes in the specified manner, as will be apparent to those skilled in the art.

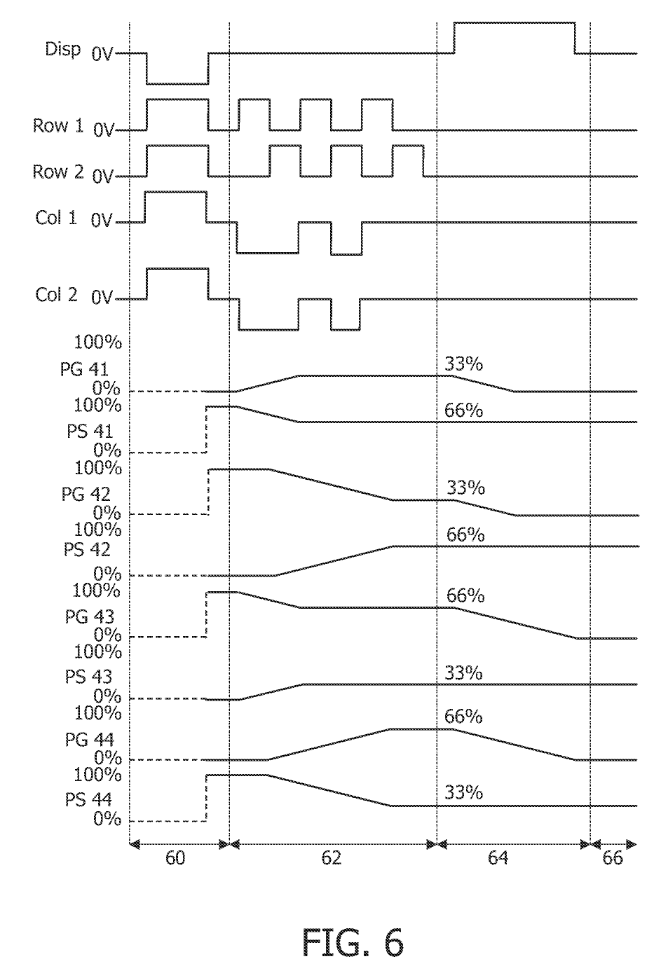

FIG. 6 shows a timing diagram for driving the display device of FIG. 5. The timing diagram shows the voltage waveforms that are applied to the Disp, Row 1, Row 2, Col 1, and Col 2 address electrodes, and also shows the resulting particle distributions between each cell's storage and gate regions. Traces PG 41-44 indicate the number of particles in the gate region of respective cells 41-44, and traces PS 41-44 indicate the number of particles in the storage region of respective cells 41-44. For example, at the beginning of time period 64, trace PG 41 shows that 33% of the particles of cell 41 are within the gate region of cell 41, and trace PS 41 shows that 66% of the particles of cell 41 are within the storage region of cell 41. At the end of time period 64, the number of particles in the gate region PG 41 has fallen to 0%, while the number of particles in the storage region PS 41 has remained at 66%, indicating that 33% of the display particles have moved to the display region of cell 41.

The timing diagram shows the rows and columns being driven to drive the first pair of cells 41 and 42 to a target optical state of a grey level of 33% (i.e. 33% of the way from transparent to black, by moving 33% of the cell's moving black particles into the cell's display region), and to drive the second pair of cells 43 and 44 to a target optical state of a grey level of 66% (i.e. 66% of the way from transparent to black, by moving 66% of the cell's black particles into the cell's display region).

Firstly, during time period 60, all of the first cells (41, 44) are set to the storage mode and all of the second cells (42, 43) are set to the gate mode. To do this, the Disp electrode is set to a negative voltage, and for each cell one of the cell's storage or gate electrodes is set to a positive voltage. Therefore, each cell's negatively charged particles move to the electrode of the cell that is set to the positive voltage. For example, at the end of time period 60, the PS 41 trace shows that 100% of the cell 41 particles are within the cell 41 storage region, i.e. that cell 41 is in the storage mode.

Next, during time period 62, the columns Col 1 and Col 2 are driven with voltages to be placed on the electrodes S1, G2, G3, and S4, and the rows Row 1 and Row 2 are driven with pulses to turn on each cell's TFT at the appropriate times. For example, cell 41 has electrodes S1, G1, D1, the gate electrode G1 being connected to 0V, and the storage electrode S1 being controlled by Row 1 and Col 1. When Row 1 is pulsed high for the first time, T1 connects the electrode S1 to the negative Col 1 voltage, setting S1 at a lower electric potential than G1, and causing particles to move from the storage region PS 41 to the gate region PG 41, as shown on FIG. 6. The negative column voltage is held on the storage electrode S1, even after the Row 1 voltage falls and turns T1 off, due to the capacitor Cs1. Then when Row 1 is pulsed high for the second time, T1 connects the electrode S1 to the 0V Col 1 voltage, setting S1 at the same voltage as G1, and therefore halting further particle movements.

In the case of cell 43, both first and second Row 1 pulses cause a negative potential to be applied to electrode G3, and so particle movements continue for a longer period of time, resulting in a higher number of particles being moved between the gate and storage regions. Hence the number of particles that are moved between each cell's gate and storage region (and hence the cell's optical state) can be controlled by the number of row pulses for which a negative voltage is applied to their gate or storage electrode.

At the end of time period 62, cells 41 and 42 have 33% of their particles in their gate regions, and cells 43 and 44 have 66% of their particles in their gate regions. Cells 41 and 44 are first cells and hence reach this state by being set to the storage mode, and then having a display number of their particles moved from their storage region to their gate region. Cells 42 and 43 are second cells and hence reach this state by being set to the gate mode, and then having a surplus number of their particles moved from their gate region to their storage region.

During time period 64, the electrode Disp is driven high, attracting the particles in each cell's gate region to the cell's display region. The number of particles in each cell's storage region remains the same since there is no significant electric field between the gate and storage electrodes. By the end of time period 64, each cell's display number of particles have been moved into the cell's display region, thereby setting each cell to its target optical state.

If the particles of all cells were to move more slowly than anticipated, for example due to a decrease in temperature, a decrease in the magnitude of the column voltages, or a negative offset in the 0V potential, then the gradients of the traces PG 41-PS 44 during time period 62 would reduce. This would cause less than 33% of the cell 41 particles to be moved into the cell 41 display region, and more than 33% of the cell 42 particles to be moved into the cell 42 display region. Therefore, cell 41 would have an optical state further from black than intended, and cell 42 would have an optical state closer to black than intended. Then when the cells 41 and 42 were viewed from a distance, the light from each of them would appear to merge, and so they would together appear as though they both had the correct optical state, i.e. a grey level of 33%. Hence the errors due to the slow particle movements effectively cancel one another out.

This invention concerns the electrode layout, and in particular the column lines which act as the discharge paths for the currents flowing to the storage capacitors Cs1 to Cs4. As shown in FIG. 5, the earthed discharge lines which couple the earth side of the storage capacitors to ground, run in the column direction. In this way, each discharge line only carries the current from a single pixel (or pair of pixels) for each addressed row.

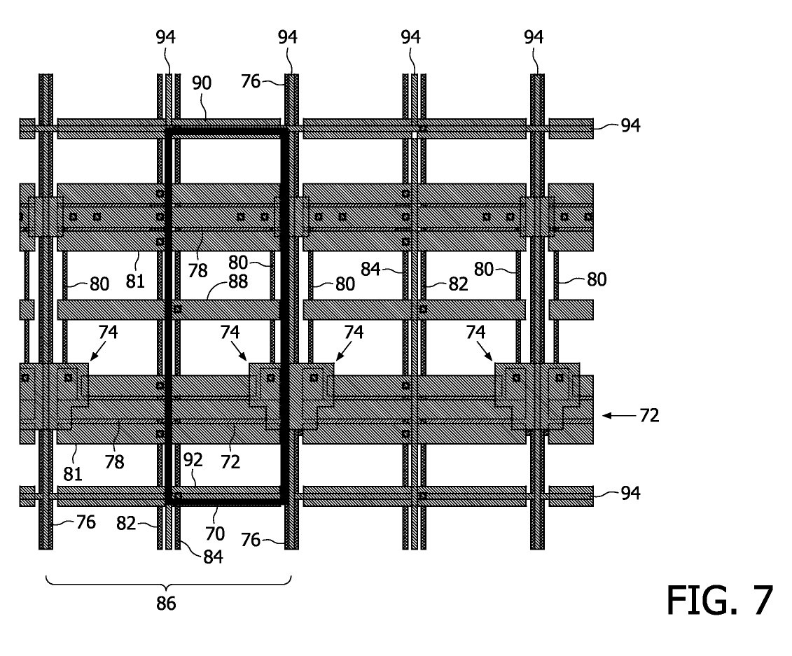

FIG. 7 shows a first example of pixel electrode layout in more detail and showing the electrode layout for pixels such as pixel 41 in FIG. 5.

FIG. 7 shows four adjacent pixel circuits in a single row. The pixel circuit layouts are designed so that the physical layout of one pixel circuit is a mirror image of the pixel circuit immediately adjacent along the row. As will become apparent from the description below, this enables a reduction in the number of addressing lines.

One particular pixel is shown with a bold outline as 70, and the electrode lines for this pixel will be described.

The row addressing line 72 runs along the row and connects to the gates of the pixel TFTs 74. For the first row of pixels of FIG. 5, this line 72 corresponds to the row line “Row 1”.

The column addressing line 76 connects to the TFT drain, as shown in FIG. 5.

The source of the TFT 74 is connected to pixel electrodes, which define the pixel side of the storage capacitor. The pixel electrodes lie above the row lines and are shown as 78. There are also two of these pixel electrodes 78, one near the top of the pixel area, and one near the bottom. This enables the movement of particles to spread across the pixel area more efficiently. A link 80 connects the two pixel electrodes 78 together.

The other side of the pixel storage capacitor is connected to ground, using the column direction discharge lines of the invention.

In the pixel arrangement of FIG. 7, one column discharge line is shared between a pair of adjacent pixels, and this is line 82. This line falls outside the area of the pixel 70.

The side of the pixel capacitor opposite the pixel electrode is shared between the pair of adjacent pixels, and this capacitor electrode is shown as 81, corresponding to the terminal G1 in pixel 41 of FIG. 5.

The display control line (Disp in FIG. 5) is also arranged as a series of column lines, again with one column line shared between a pair of adjacent pixels. This is line 84.

It can be seen, therefore, that two adjacent pixels 86 together have one row line 72, one Display line 84 shared between the adjacent pixels, one column discharge line 82 shared between the adjacent pixels and two column lines 76. It can thus be seen how the pixel layout of FIG. 7 maps to the pixels in the circuit of FIG. 5. The symmetry of the layout can also be seen in FIG. 7.

The column discharge line, which is connected to ground, is also connected to a central spur 88, as well as to top and bottom ground electrodes 90, 92.

The particle movement is thus controlled between the three-grounded spurs 88,90,92 and the pixel electrode areas 78. In this way, the pixel area is effectively divided into top and bottom halves, but the circuit may be considered to correspond to FIG. 5, with each storage capacitor Cs representing the combined effect of the different pixel areas.

The storage capacitor is defined by the regions 78 and 81, and thus comprises two portions, which extend in the row direction across the pixel aperture. The current flow discharges down a column line. These column discharge lines carry the currents, which flow to them from the two adjacent pixels, in particular the currents flowing to the grounded areas 88,90,92. As shown, the grounded areas 88,90,92 only extend in the row direction between the two adjacent pixels.

The cell walls are shown in FIG. 7 as lines 94.

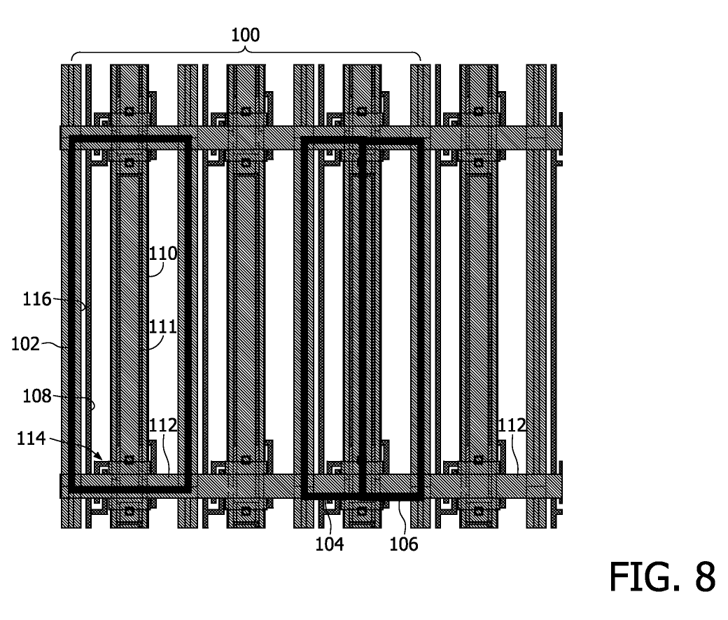

FIG. 8 shows an alternative layout, in which each pixel comprises three sub-pixels. One pixel is shown as 100. One sub-pixel is shown by the bold outline 102. Each sub-pixel is associated with color filters. Furthermore, each sub-pixel is divided into two optically identical halves 104 and 106 to improve speed by reducing the particle distance (and increasing the field for a given voltage).

Each sub-pixel has the column data line 108 running in the column direction to one side of the pixel aperture. The central column direction line 110 defines the common capacitor electrode (G1 in pixel 41 of FIG. 5) and the pixel electrode 111 is on top, and the column discharge line beneath. In this way, the pixel storage capacitor is defined by the central column line 110. The row conductor is shown as 112, and the TFT as 114.

The display control line “Disp” runs in the column direction at one edge of the pixel, for example as shown as 116. This can be shared between adjacent pixels.

This layout provides a more simple pixel design arranged as a regular pattern.

The connections between layers are made with appropriate vias. Some of these can be seen in FIGS. 7 and 8, but no detailed description will be given, as implementation of the required detailed mask patterns will be routine to those skilled in the art.

In the examples of FIGS. 7 and 8, the pixels (or sub-pixels) are elongate in the column direction, so that a sub-pixel triplet defines a substantially square pixel. This means the discharge lines run along the long axis of the sub-pixels. This would suggest that the column discharge lines occupy a larger area of the pixel aperture than if they were to run in the row direction. However, the reduction in current flowing along the discharge line means the width can be reduced, and there is therefore still a possible increase in available pixel aperture.

It will be clear from the examples of FIGS. 7 and 8 and there are many different ways to implement the pixel layout to provide column discharge lines.

Although two possible layouts are shown for the pixel circuit of FIG. 5, it will be appreciated that other pixel circuits can be used, for example simpler pixel circuits, which do not use the display control line “Disp”.

In the above, a system for driving a moving particle display device, such as an electrophoretic display device, is described. The display device comprises first and second cells that are set to target optical states to give the cells' their target optical appearances. The first and second cells are driven differently from one another, such that errors in the first cell's target optical state occur in the opposite direction to errors in the second cell's target optical state. Hence, when the cells are viewed from a distance by a viewer of the display, the light from the first and second cells mixes together, and the optical state errors appear to compensate or cancel one another out.

One particular drive scheme has been described in detail, but it will be understood that many other drive schemes are possible. With respect to the detailed scheme described, it is to be understood that the first and second cells of the or each pair are referred to as first and second cells simply because of the different drive methods that are used to drive them. It may be possible for a first cell to effectively become a second cell, simply by driving the first cell as though it were a second cell. The physical structures of the first and second cells may be identical, or they may be different, for example due to having different address electrode connections.

There are many other variations on the cell arrangements and drive schemes described herein that also fall within the scope of the appended claims, as will be apparent to those skilled in the art. Indeed, a more conventional addressing scheme may be employed, in which each row is addressed independently.

1. A moving particle display device comprising:
an array of rows and columns of display pixels (41,42,43,44);
a plurality of row address lines (Row1,Row2;72;112), each row address line for addressing a respective row of pixels;
a plurality of column address lines (Col1,Col2;76;108), each for providing pixel data to a respective column of pixels; and
a plurality of discharge column lines (82),
wherein a pixel is addressed by addressing a row of pixels and providing data to the pixels in the addressed row using the column address lines (Col1,Col2;76;108), and wherein a charge flow from a column address line to an addressed pixel in the column flows to a respective discharge column line (82).

2. A device as claimed in claim 1, wherein each pixel comprises a cell comprising a sealed region containing a fluid (212) in which particles (28;36) are suspended, wherein the movement of particles within each cell is controlled to define a cell state, the cell states of all device cells together defining an output of the device.

3. A device as claimed in claim 1, comprising an electrophoretic device, in which the moving particles (28;38) comprise electrophoretic particles.

4. A device as claimed in claim 3, comprising an in-plane switching electrophoretic display device.

5. A device as claimed in claim 1, wherein each column discharge line (82) is shared between two adjacent columns of pixels.

6. A device as claimed in claim 1 wherein each column discharge line (82) is associated with a single columns of pixels.

7. A method of driving a moving particle display device comprising an array of rows and columns of display pixels (41,42,43,44), the method comprising:
addressing rows of pixel in a sequence, a row of pixels being selected by applying a row select signal to a respective row address line (Row1,Row2;72;112);
when a row of pixels is addressed, loading the pixels of the row with data using column address lines (Col1,Col2;76;108),
wherein during loading of data from a column address line (Col1,Col2;76;108), a charge flow from the column address line (Col1,Col2;76;108) to an addressed pixel (41,42,43,44) in the column is discharged along a respective discharge column line (82).

8. A method as claimed in claim 7 for driving an electrophoretic display device, in which the moving particles (28;38) comprise electrophoretic particles.

9. A method as claimed in claim 8, for driving an in-plane switching electrophoretic display device.

10. A method as claimed in claim 7, wherein each column discharge line (82) is shared between two adjacent columns of pixels, such that each column discharge line discharges the charge flow to two adjacent pixels in a row.
